(19) United States
(12) Patent Application Publication
(10) Pub. No.: US 2002/0111836 A1
(43) Pub. Date: Aug. 15, 2002

(54) Process control system and computer readable storage medium for storing process control program

(75) Inventor: Tateo Uegaki, Sendai (JP)

Correspondence Address: BURR & BROWN, PO BOX 7068, SYRACUSE, NY, 13261-7068, US

(73) Assignee: E.A.C Co., Ltd.

(21) Appl. No.: 09/753,241

(22) Filed: Dec. 29, 2000

(51) Int. Cl. G06F 17/60

(52) U.S. Cl. 705/5

(57) ABSTRACT

In a process control system, process operations of repair shops for repairing damaged vehicles are automatically controlled by way of a computer program. The process control system is provided with a display apparatus for displaying an image, a storage apparatus for storing repair-reserved data, and a control unit. The control unit causes the display apparatus to display thereon repair-reservable day/time based upon the repair-reserved data stored in the storage apparatus, and then makes a repair-reservation on the proper repair-reservable day/time displayed on the display apparatus. In accordance with the process control system, repair reservations of vehicles can be readily made by users.

### BACKGROUND OF THE INVENTION

1. Field of the Invention

The present invention relates to a system capable of controlling repair process operations of repair shops for repairing damaged vehicles and the like.

In repair factories, when repair requests of damaged vehicles issued from users are accepted, working scheduled dates should be determined.

2. Description of the Related Art

Conventionally, in order to determine working scheduled dates of repair-requested vehicles, managers directly hand-write these scheduled dates on schedule tables with date indications (e.g., calendars made of paper and chalkboards).

To more correctly perform reserved working activities, such an idea is conceivable. That is, a repair-reservation control may be carried out by utilizing computers.

However, as repair-reservation control systems of repair working activities by using computers, while using simple calendar programs, such reservation working activities substantially equal to hand-writing reservation working activities are merely carried out in a relatively higher efficiency.

Therefore, repair factories would strongly expect developments of process control systems capable of controlling schedules with respect to each of working staffs and also controlling progress conditions of repair working activities in a batch mode.

### SUMMARY OF THE INVENTION

To realize the above-explained requirements in process control systems, according to one aspect of the present invention, there is provided a process control system comprising: display means for displaying thereon an image; repair-estimation time input means for inputting repair estimation time of a vehicle to be repaired; repair-reserved data storage means for storing a repair-reserved data; repair-reservable day/time data display means for displaying a repair-reservable day/time on the display means based upon the repair-reserved data of the repair-reserved data storage means; and repair reservation determining means for determining a repair-reservation on the repair-reservable day/time displayed on the display means.

This process control system further comprises repair-reservable day/time calculating means for calculating a repair-reservable day/time based upon both the repair estimation time inputted from the repair-estimation time input means and the repair-reserved data stored in the repair-reserved data storage means. The repair-reservable day/time data display means may display the repair-reservable day/time calculated by the repair-reservable day/time calculating means on the display means.

The repair-estimation time input means of this process control system may be constituted by repair-estimation time calculating means for calculating repair-estimation time based upon various sorts of data as to a repairing portion of a vehicle.

Also, the repair-reserved data storage means of this process control system may store thereinto repair-reserved data as to a plurality of repair work pits, the repair-reservable day/time data display means may display repair-reservable day/time of each of the plural pits, and the repair-reservation determining means may select any one of the repair-reservable day/time of the respective pits to thereby determine a repair reservation.

Also, this process control system may further comprises repair-reservation completion day/time data display means for displaying repair-reservation completion day/time based upon the repair-reserved data stored in the repair-reserved data storage means, and repair-reservation day/time changing means for changing the repair-reservation completion day/time into another repair-reservable day/time.

Also, this process control system may further comprises working time input means for inputting actual repair work time which is actually consumed, and work time comparing means for comparing estimated repair work time with the actual repair work time.

Also, the repair-estimation time input means of this process control system may input estimated repair work time with respect to each of plural work items, the working time input means may input actual repair work time with respect to each of the plural work items, and the work time comparing means may compare estimated repair-work time with work time of each of the work items of the actual repair work time.

Also, the repair-reservable day/time data display means of this process control system may display workable time per day on a time axis displayed on the display means, and the repair-reservation determining means may display the estimated repair work time of the vehicle to be repair-reserved on a time axis in the same unit of the time axis displayed by the repair-reservable day/time data display means.

In accordance with the process control system of the present invention, the repair reservations of the vehicles can be readily made in a proper manner. Also, the reservations of the repair works can be effectively rearranged. Furthermore, the repair work activities of the repair factory, or the repair working staffs can be accurately evaluated.

According to another aspect of the present invention, there is provided a computer readable storage medium for storing therein a program, in which the program is used to cause computer to display repair-reservable day/time on display means based upon repair-reserved data, and also to determine a repair reservation on the repair-reservable day/time displayed on the display means, and the computer comprises the display means for displaying thereon an image, input means for inputting data, and storage means for storing the repair-reserved data.

In this case, the display means may be exemplified as a CRT (cathode-ray tube) and a liquid crystal display. Also the repair-reserved data storage means may be exemplified as a hard disk drive. Both the repair-estimation time input means and the working time input means may be exemplified as a mouse and a keyboard. Also, the repair-reservable day/time data display means, the repair-reservation determining means, the repair-estimation time input means (repair-estimation time calculating means), the repair-reservable day/time calculating means, the repair-reservation completion day/time data display means, the repair-reservation day/time changing means, and the work time comparing means may be exemplified as a CPU (central processing unit).

### BRIEF DESCRIPTION OF THE DRAWINGS

A better understanding of the present invention may be made by reading a detailed description in conjunction with the accompanying drawings, in which:

FIG. 1 is a schematic block diagram for indicating a circuit arrangement of a process control system according to an embodiment of the present invention;

FIG. 2 is a flowchart for describing a control process operation executed in a control unit of the process control system shown in FIG. 1;

FIG. 3 is a flow chart for describing another control process operation executed in the control unit of the process control system shown in FIG. 1;

FIG. 4 illustratively indicates an example of images displayed on a display apparatus of FIG. 1, namely, a customer/vehicle information input screen;

FIG. 5 illustratively shows an example of images displayed on the display apparatus of FIG. 1; namely, a damaged portions selection screen;

FIG. 6 illustratively shows an example of images displayed on the display apparatus of FIG. 1; namely, another damaged portions selection screen;

FIG. 7 illustratively indicates an example of images displayed on the display apparatus of FIG. 1, namely, an estimated specification input screen;

FIG. 8 illustratively shows an example of images displayed on the display apparatus of FIG. 1; namely, a repair-reservation condition confirmation screen;

FIG. 9 illustratively shows an example of images displayed on the display apparatus of FIG. 1; namely, another repair-reservation condition confirmation screen;

FIG. 10 illustratively indicates an example of images displayed on the display apparatus of FIG. 1, namely, repair-reservation input screen;

FIG. 11 illustratively shows an example of images displayed on the display apparatus of FIG. 1; namely, a further repair-reservation condition confirmation screen;

FIG. 12 illustratively indicates an example of images displayed on the display apparatus of FIG. 1, namely, a worked activities input screen;

FIG. 13 illustratively shows an example of images displayed on the display apparatus of FIG. 1; namely, an accidental vehicle worked activities input screen; and

FIG. 14 illustratively indicates an example of images displayed on the display apparatus of FIG. 1, namely, a sales activities confirmation screen.

### DETAILED DESCRIPTION OF THE PREFERRED EMBODIMENTS

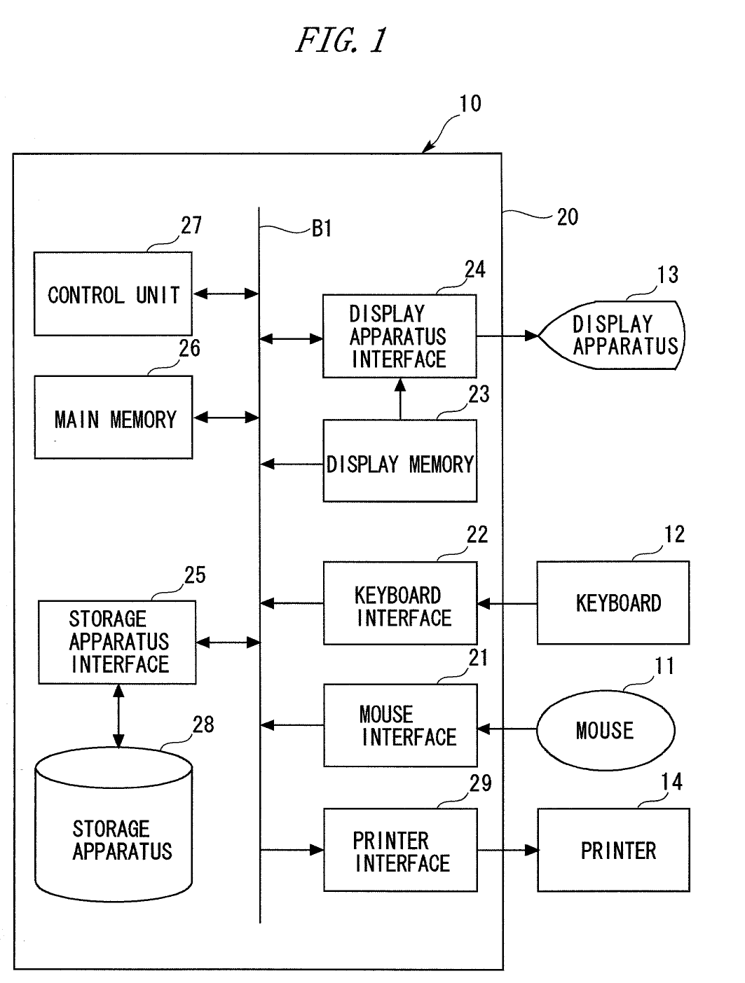

Hereinafter, embodiments of the present invention will be described with reference to FIG. 1 to FIG. 14.

FIG. 1 schematically shows a process control system 10 according to an embodiment of the present invention.

As shown in FIG. 1, the process control system 10 is constituted by a mouse 11, a keyboard 12, a display apparatus 13, a printer 14 and a computer main body 20.

Also, the computer main body 20 is constituted by a mouse interface 21, a keyboard interface 22, a display memory 23, a display apparatus interface 24, a storage apparatus interface 25, a main memory 26, a control unit 27, and a printer interface 29, which are mutually connected via a bus B1 to each other, and is further constituted by a storage apparatus 28 connected to the bus B1 via the storage apparatus interface 25.

Also, the mouse 11 is connected via the mouse interface 21 to the bus B1, the keyboard 12 is connected via the keyboard interface 22 to the bus B1, the display apparatus 13 is connected via the display apparatus interface 24 to the bus B1, and also the printer 14 is connected via the printer interface 29 to the bus B1.

Both the mouse 11 and the keyboard 12 is such an apparatus used by an operator for inputting data and the like. These mouse 11 and keyboard 12 correspond to an estimation time input means and a working time input means.

The display apparatus 13 is such an apparatus capable of displaying thereon an image of a vehicle, an image indicative of day/time required for a repair reservation, characters and the like, which are inputted by using the keyboard 12. The display apparatus 13 corresponds to a display means.

The computer main body 20 is such an apparatus used to execute a computer program.

The mouse interface 21 is such an apparatus that receives data inputted by a user from the mouse 11 and then transfers the received data to the bus B1.

The keyboard interface 25 is such an apparatus that receives data inputted by a user from the keyboard 12 and then transfers the received data to the bus B1.

The display memory 23 is constituted by a RAM (random access memory) and the like. This display memory 23 is such a memory capable of storing thereinto data such as characters and images displayed on the display apparatus 13.

The display apparatus interface 24 is such an apparatus for causing the display apparatus 13 to display thereon characters, images, and the like.

The storage apparatus 28 is such a hard disk apparatus capable of storing a program processed by the control unit 27; various sorts of data such as vehicle lengths, vehicle widths, and vehicle heights; data of vehicle shapes; and furthermore data as to repair-reservable day/time and repair-reservation completion day/time with respect to each of working pits. The various sorts of data correspond to vehicle specific data constructed of classification number data, model data, year model data, and the like, which are used to specify vehicles. Also, the data of vehicle shapes corresponds to the vehicle specific data. Then, this storage apparatus 28 corresponds to a repair-reservation data storage means.

The storage apparatus interface 25 is such an apparatus for writing data into the storage apparatus 28, and also for reading data from the storage apparatus 28.

The main memory 26 is constructed of a RAM and the like, and is such a memory employed for a work memory of the control unit 27.

The control unit 27 is constituted of a CPU (central processing unit) and the like. This control unit 27 writes data such as characters and images into the display memory 23, and instructs the display apparatus interface 24 to display an image. Also, the control unit 27 instructs the storage apparatus interface 25 to write data into the storage apparatus 28, and to read out data from the storage apparatus 28. Furthermore, the control unit 27 receives input data from the mouse 11 via the mouse interface 21, and also receives input data from the keyboard 12 via the keyboard interface 22. Also, the control unit 27 executes a process operation of data such as characters which are inputted from both the mouse 11 and the keyboard 12, and executes a process operation of screen data displayed on the display apparatus 13. In addition, the control unit 27 instructs the printer 14 via the printer interface 29 to print out. Then, this control unit 27 corresponds to a repair-reservable day/time data display means, a repair-reservation determining means, an estimation time input means (estimated repair time calculating means), a repair-reservable day/time calculating means, a repair-reservation completion day/time data display means, a repair-reservation day/time changing means, and also a work time comparing means.

21 Description of Operation of Embodiment>

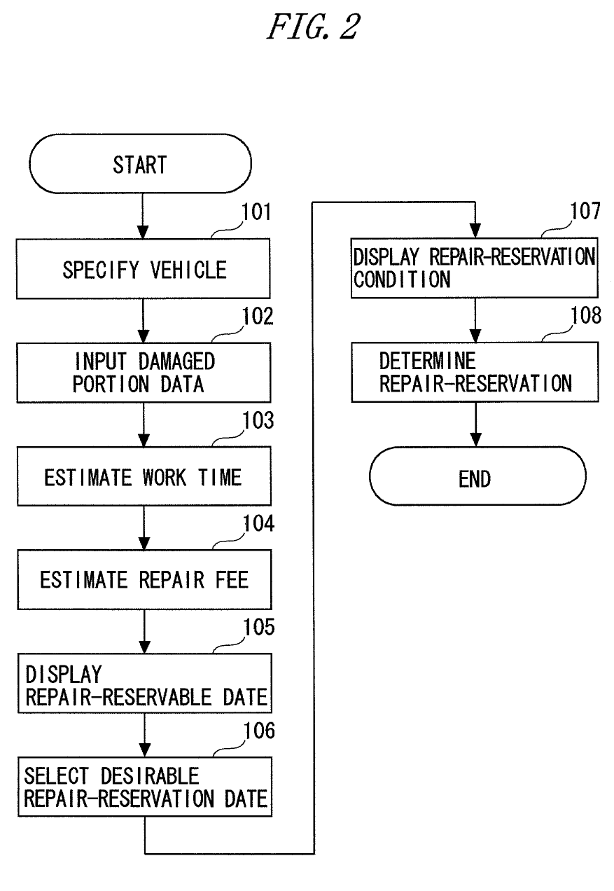

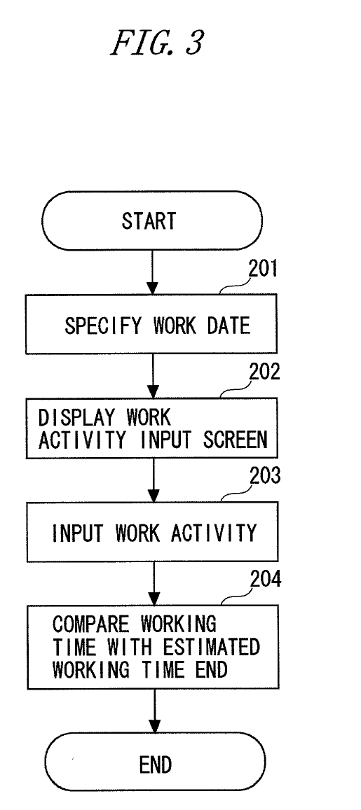

Next, contents of control operations which are realized by executing the program stored in the storage apparatus 28 by the control unit 27 will now be explained with reference to, mainly, flow charts shown in FIG. 2 and FIG. 3.

When the control unit 27 receives such instruction data for instructing a commencement of a repair reservation work from either the mouse 11 or the keyboard 12, the control unit 27 starts a control operation defined in the flow chart shown in FIG. 2.

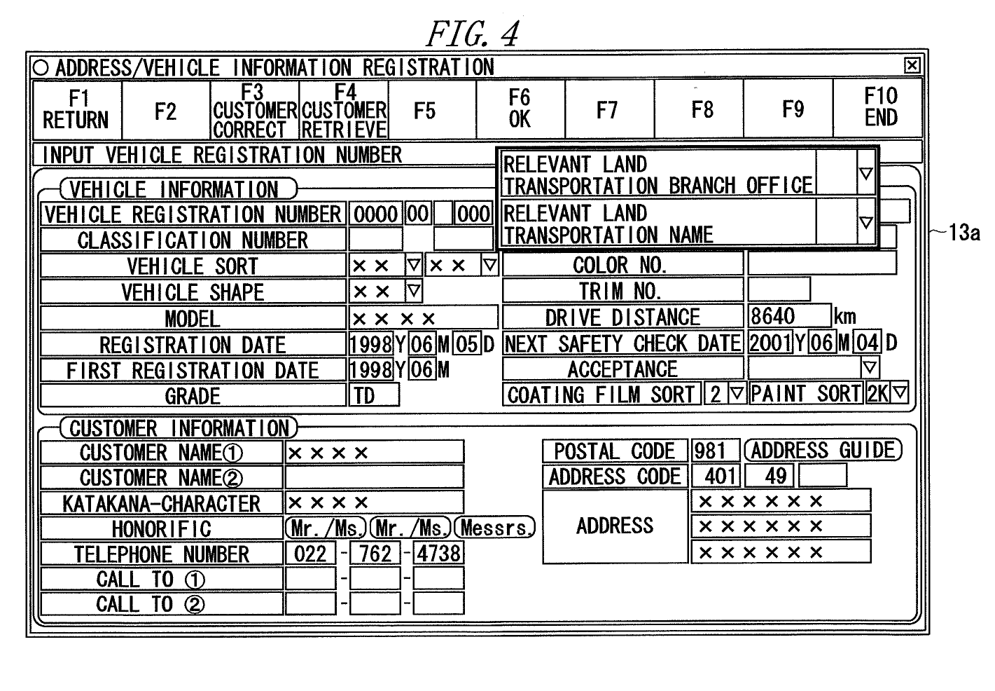

After the control operation is commenced, at a first step 101, the control unit 27 displays a screen 13a on the display apparatus 13. This screen 13a corresponds to a customer/vehicle information input screen shown in FIG. 4. Then, the control unit 27 checks as to whether or not vehicle specific data is inputted from either the mouse 11 or the keyboard 12. Then, after the vehicle specific data is input, the control process is advanced to a step 102.

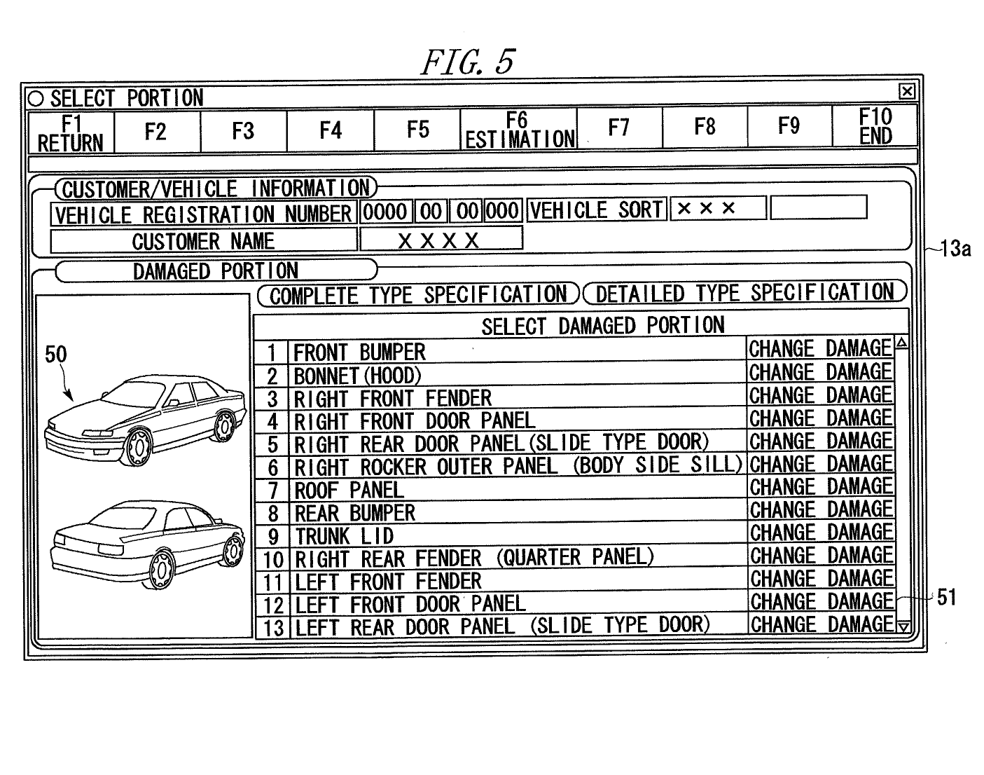

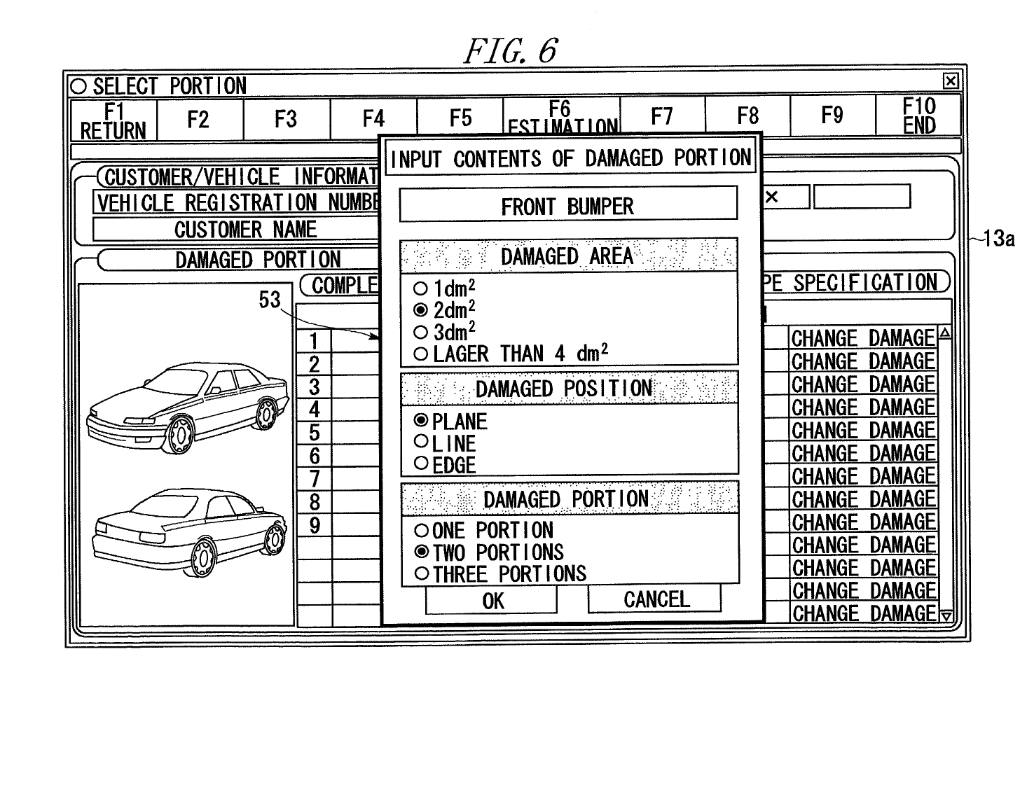

In the next step 102, the control unit 27 displays a screen 13a corresponding to a damaged portion selection screen shown in FIG. 5 on the display apparatus 13. The control unit 27 checks as to whether or not a damaged portion of a vehicle is inputted from either the mouse 11 or the keyboard 12. When this damaged portion is input, since a portion displayed on a damaged portion selection column 51 of FIG. 5 is selected, a color display of a position of this selected portion of a vehicle image 50 is changed. Then, on a screen 13a of FIG. 6, damage contents such as damaged areas, damaged positions, and damaged position numbers are inputted in a damage content input column 53 with respect to each of selected portions.

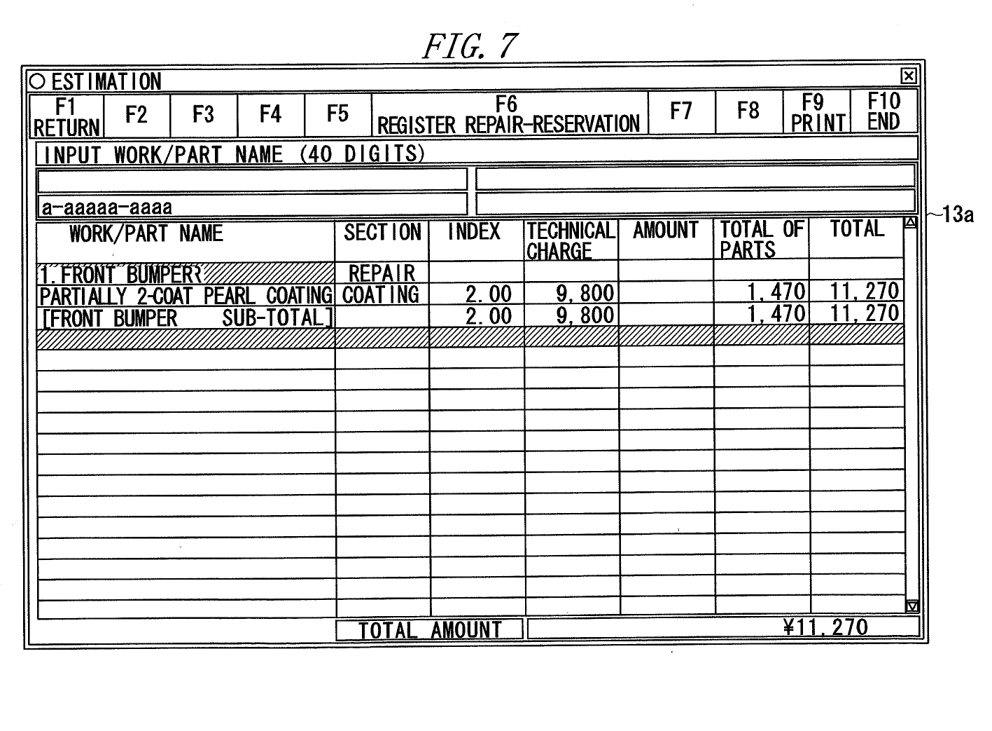

Then, the control unit 27 estimates working time based upon the above-described damaged content data (step 103), and also estimates a repair fee (step 104). In this step, when the control unit 27 makes this estimation, such a screen 13a corresponding to an estimation specification input screen shown in FIG. 7 may be displayed on the display apparatus 13 so as to confirm a content of a repair work and parts. Also, the control unit 27 may change a detailed content of the estimation.

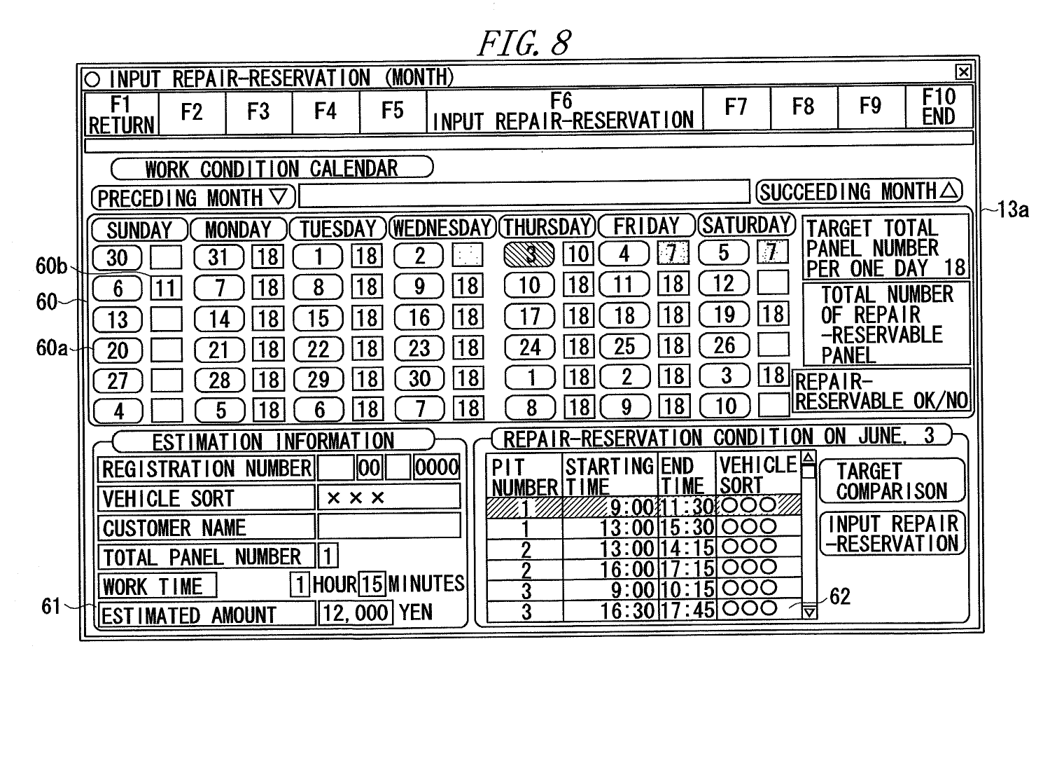

Next, the control unit 27 displays such a screen 13a corresponding to a reservation condition confirmation screen shown in FIG. 8 on the display apparatus 13. In this case, the display apparatus 13 displays thereon a calendar column 60 displaying a summary of reservation conditions every month, an estimation information column 61 displaying estimation information of vehicles to be repair-reserved, and a specific date reservation condition column 62 displaying a detailed reservation condition of a designated specific date. The above-mentioned calendar column 60 is constituted by a date column 60a, and a reservation panel number column 60b provided with each of date columns. The reservation panel number indicates a total number of repair-scheduled panels of a vehicle, namely a total number of left-front door panels, bonnet panels, and the like. Then, the control unit 27 checks as to whether or not each of calendar date can be repair-reserved on the calendar column 60, and indicates the check result of the above-mentioned date by changing a color indication of the reservation panel number column 60b (step 105). For example, the display apparatus 13 displays a reservation panel number column corresponding to a repair-reservable date in blue color, and also displays a reservation panel number column corresponding to a repair-not-reservable date in red color. Alternatively, the reservation panel number column 60b may be arranged in such a manner that while a preset total target panel number (for example, 18 panels) per day is employed as a threshold value, a color indication is changed.

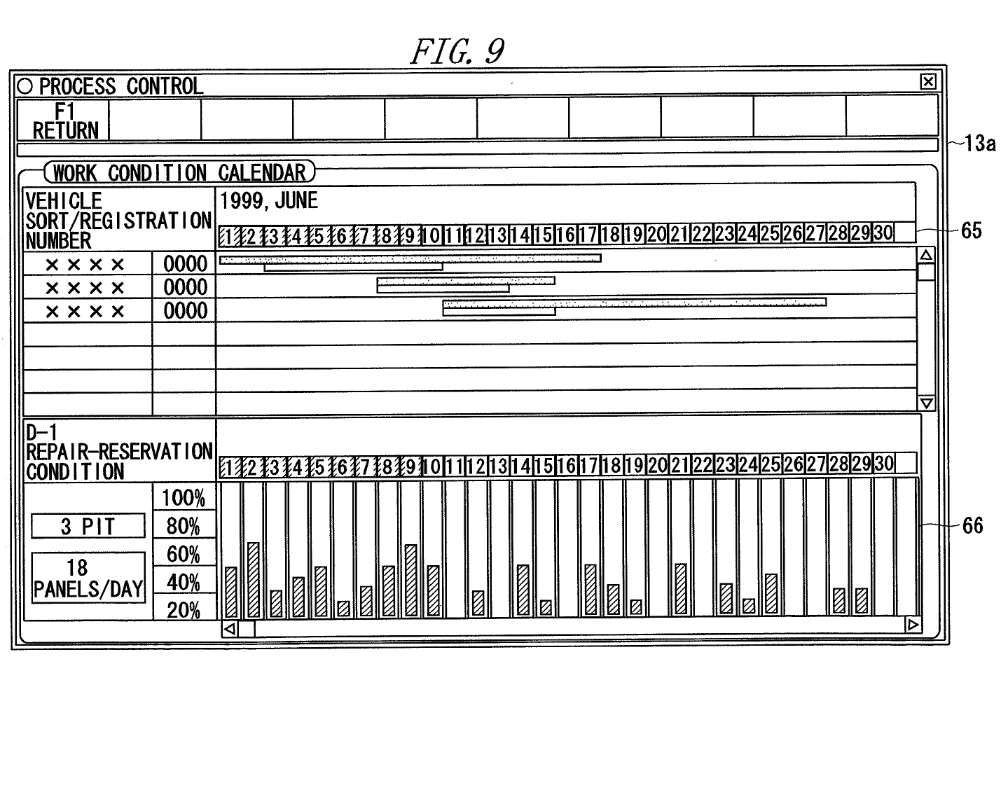

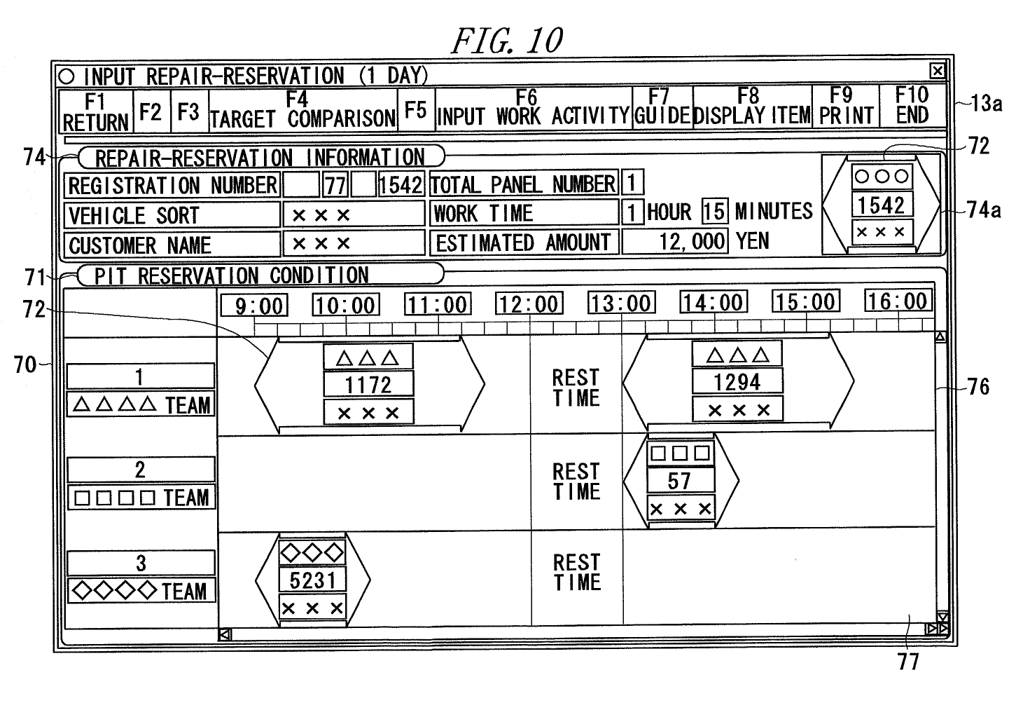

Assuming now that, for instance, “Jun. 3” is selected as a desirable repair-reservation date (step 106), the control unit 27 displays such a screen 13a corresponding to a reservation input screen shown in FIG. 10. It should be understood that a reservation condition confirmation screen shown in FIG. 9 corresponding to such a screen which is used to confirm a repair reservation of a seriously-damaged accidental vehicle. In the case that such a seriously-damaged accidental vehicle is repaired, a repair work should be carried out over a long repairing time duration, which is different from a general-purpose sheet plate/coating repair work (namely, repair work for a small-damaged accidental vehicle is accomplished for several hours) . As a result, a scheduled work date with respect to each of specific vehicles can be displayed in the unit of on month in a specific vehicle work calendar column 65. Also, on the screen 13a shown in FIG. 9, a specific system reservation condition column 66 indicative of a reservation condition of a specific vehicle repair system(D-1) may also be displayed on this screen 13a of FIG. 9.

A reservation input screen (13a) shown in FIG. 10 is provided with a repair-reservation input vehicle data column 74 indicating individual data of a vehicle to be reserved, and a pit-reservation condition column 70 indicating a reservation condition of each of pits (namely, 3 pits in this embodiment) of a desirable repair date.

The above-explained reservation input vehicle data column 74 is constituted by such displays of the following items and an indication of an individual working time indication member 72. These items are indicated registration numbers, vehicle sorts, customer names, total repair panel quantities, estimated working periods, estimated repair amounts as to vehicle which will be repair-reserved. The individual working time indication member 72 is made by that a total time amount of estimated working time is indicated by way of a dimension of a lateral direction (time axis). It should be noted that the above-explained individual working time indication member 72 is displayed within a reservation input vehicle display unit 74a, and is constituted by indicating the vehicle registration number, the vehicle work name, and the customer name in an integral form.

The pit-reservation condition column 70 is equipped with a working schedule table portion 76. This working schedule table portion 76 indicates that the respective pit names correspond to working time per one day with respect to each of these pits on an abscissa (namely time axis) 71. Then, when the individual working time display member 72 is input into this work schedule table portion 76, a reservation of a pit is made within such a time period occupied by the individual working time display member 72 (step 108). When the individual working time display member 72 is input into the work schedule table portion 76, for example, the individual working time display member 72 indicated in the above-explained reservation input vehicle display unit 74 may be moved into a reservation empty column portion 77 of the work schedule table portion 76 by dragging the mouse 11. In this case, when an unreserved time amount of the reservation empty column portion 77 does not exceed the working time amount of the individual working time table member 72 within the reservation input vehicle display unit 74, no individual working time display member 72 can be input, namely in such a case that the lateral width of the individual working time display member 72 within the reservation input vehicle display unit 74 is larger than the reservation empty column portion 77. For reference, while a time domain (work schedule table portion 76) in each of these pits into which the individual working time display member 72 within the reservation input vehicle display unit 74 can be input is displayed in blue color, another time domain into which the individual working time display member 72 cannot be input is displayed in red color. As a result, such a color indication may cause an operator to easily confirm such a fact that the individual working time display member 72 may be input to which reservation empty column 77.

Also, the respective working time indication members 72 which are input (registered) into the pit reservation condition column 70 are properly moved to other time domains and other pits, so that the pit reservation can be changed. Furthermore, the control unit 27 may automatically input a pit reservation into the pit reservation condition column 70 based upon specific data of the individual working time indication member 72 contained in the reservation input vehicle display unit 74. This specific data involves work time, work difficulty degrees, necessary work tools, and the like. In this case, the control unit 27 makes a reservation decision in order that, for example, vehicles whose repair difficulty degrees are high are not concentratedly allocated to a specific pit. Alternatively, the control unit 27 may make such a reservation with a top priority that vehicles whose repair difficulty degrees are high are allocated to such a pit (team) to which skilled working staffs belong. Also, the individual working time indication members 72 for reserved repairs, or the repairs-reservation may be rearranged in order that half-done empty working time does not occur, while judging total working time of the respective pits.

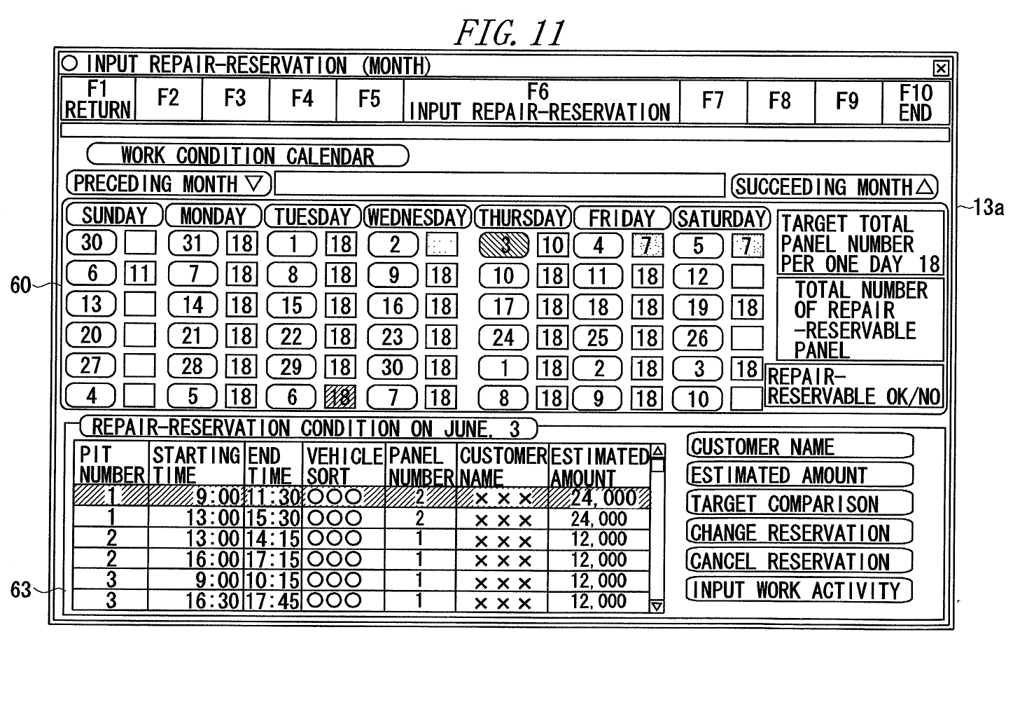

It should be understood that after the reservation input operation is ended, such a screen 13a corresponding to a reservation condition confirmation screen shown in FIG. 11 is displayed on the display apparatus 13, by which the operator can confirm the entire reservation conditions. On the screen 13a shown in FIG. 11, both the above-explained calendar column 60 and specific date reservation condition column 63 are displayed. This specific date reservation condition column 63 displays a detailed reservation condition of a designated specific date.

Next, when the control unit 27 receives from either the mouse 11 or the keyboard 12 such date for instructing a commencement of a working activity input work, this control unit 27 starts a control operation indicated in FIG. 3.

After the control operation is commenced, at a first step 201, the control unit 27 checks as to whether or not data as to a specific date designated by either the mouse 11 or the keyboard 12 is inputted. This specific date corresponds to, for example, a working day of a work activity input work. Then, after the date data has been input, the control process is advanced to a step 202. Furthermore, the control unit 27 may check as to whether or not the vehicle specific date is input at the step 201, and when the vehicle specific data is inputted, this control process may be advanced to the step 202.

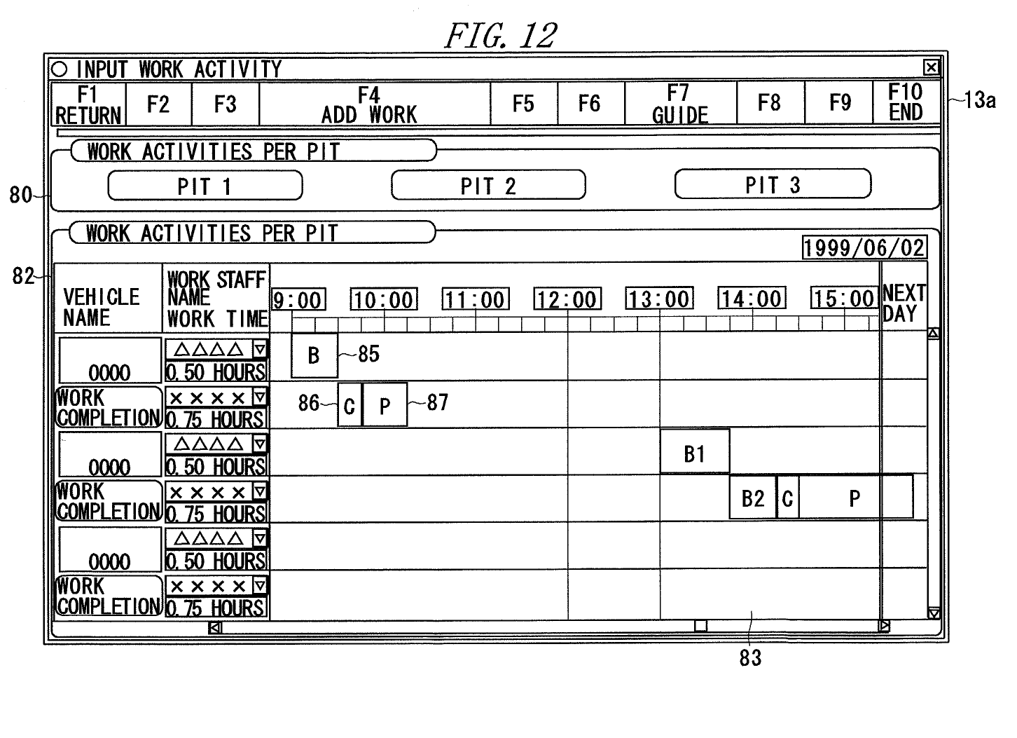

At a step 202, the control unit 27 displays such a screen 13a corresponding to a work activity input screen indicated in FIG. 12 on the display apparatus 13. The screen 13a of FIG. 12 is provided with a pit name display column 80 indicative of each of pit names, and a detailed pit work column 82. When an individual pit displayed on this bit name display column 80 is selected, the detailed pit work column 82 indicates a work condition of the relevant date in the selected pit. The detailed pit work column 82 contains a work activity column 83 capable of displaying both work time and a work content with respect to each of vehicles in correspondence with a time axis. For reference, the work activity column 83 can be adapted to display the work activity every vehicle and working staff, respectively. In this case, a work content (B) 85 inputted in this work activity column 83 indicates a sheet metal work; another work content (C) 86 inputted thereinto represents a coloring work; and a work content (P) 87 entered thereinto shows a coating work. Preferably, the contents of these works may be automatically registered as work contents and work time of the respective working staffs based upon the estimated work time while the repair reservation is made. In other words, on the screen 13a of FIG. 12, the work activity is inputted by correcting the work contents (estimated work content and estimated work time) of the relevant work date, which are read by the control unit 27 resulting in inputting the work activity. While the work content such as work time period is corrected, the work content (B) 85 may be directly corrected by dragging the mouse 11.

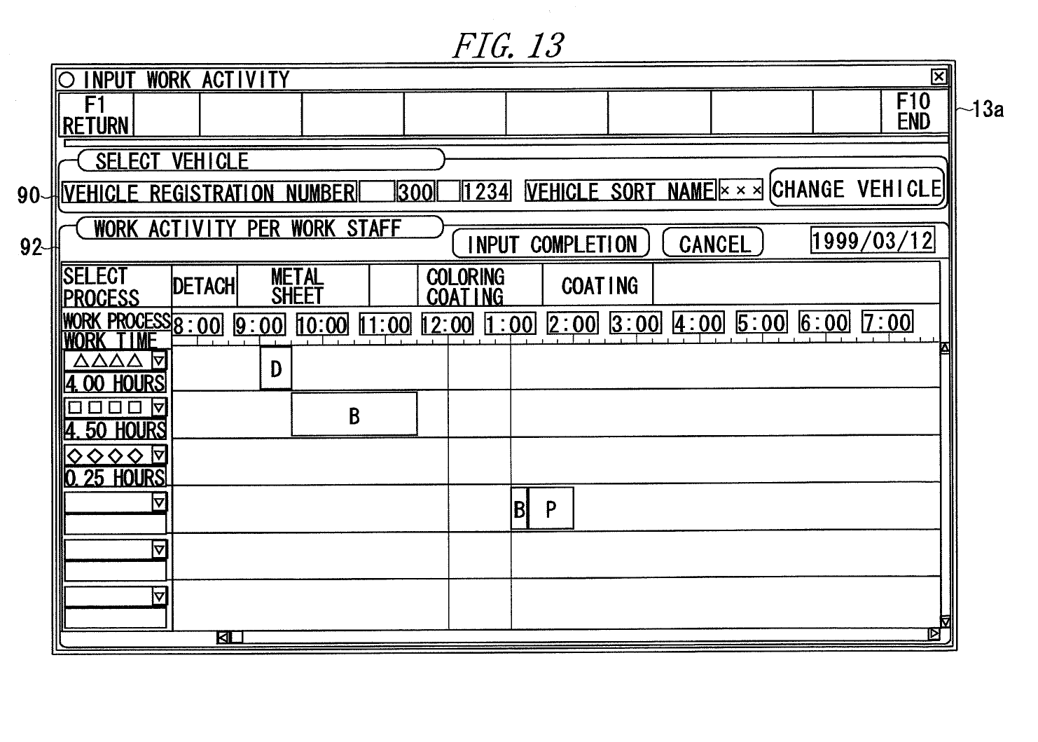

A screen 13a which is equal to an accidental vehicle work activity input screen shown in FIG. 13 corresponds to a work activity input screen for a seriously-damaged vehicle. This screen 13a shown in FIG. 13 is provided with a data display column (vehicle selecting unit) 90 of a specific vehicle and a work activity column 92 of the relevant pit of this vehicle.

Next, the control unit 27 compares the content of the inputted work activity with the content of the work estimation that is registered when the repair work is reserved at a step 204. This comparison process operation is carried out so as to evaluate a work efficiency based upon, for example, such a value obtained by subtracting actual work time form the estimated work time. In this case, both the work efficiency per one bit, and the work efficiency per one working staff can be evaluated. Furthermore, while data are accumulated, work efficiency in unit of a repair factory may be evaluated.

Since the control unit 27 compares the estimated work time with the actual work time with respect to each of the work contents, the control unit 27 can concretely evaluate a work efficiency in a work content with respect to each of the specific pits and each of the working staffs. In other words, for instance, the control unit 27 may evaluate that a metal sheet working efficiency in a pit 1 is high, but coating work efficiency is low. Therefore, the control unit 27 may indicate an improvement in the work efficiency.

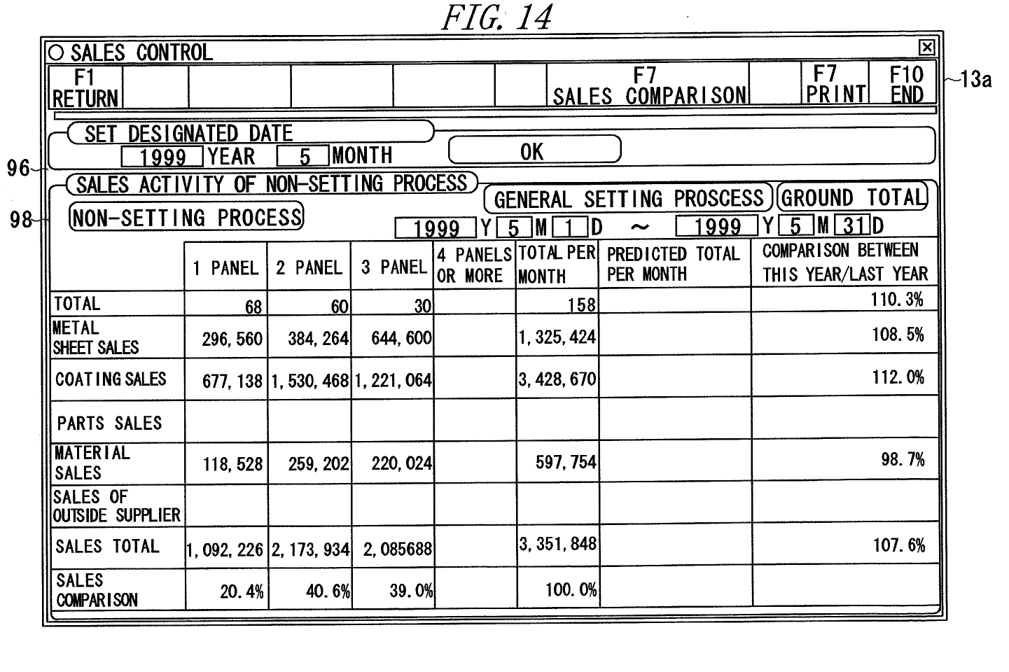

Then, the control unit 27 may collect an entire sales activity based upon the inputted various sorts of data. FIG. 14 represents a screen 13a corresponding to a sales activity confirmation screen that is displayed on the display apparatus 13 by the control unit 27. This screen 13a shown in FIG. 14 is provided with a designated year/month setting column 96 and a sales activity indication column 98. The designated year/month setting column 96 sets a time period in unit of a month. The sales activity indication column 98 indicates a detailed sales activity of the relevant month. It should also be noted that detailed sales data may be indicated in this sales activity indication column 98, while the repairing method is subdivided into both a specific repairing method (non-setting method) and a general-purpose method.

Incidentally, for example, while the process control systems according to this embodiment are installed in a plurality of factories, and are connected to each other in an on-line mode, a united process control system capable of controlling the plural factories may be constituted. In this case, for instance, when such a terminal apparatus connectable to this process control system is installed in a loss insurance company, even this loss insurance company may grasp working conditions of the respective on line-connected factories in a real time mode. As a result, vehicle repair requests issued from this loss insurance company to the factory can be properly distributed.

As previously described in detail, in accordance with the process control system of this embodiment, while both the work process and the work time can be automatically calculated from the estimated contents, the vehicle repair request can be reserved by performing a simple manipulation. As a result, the reservation condition can be correctly grasped, and also the proper work instruction can be made with respect to the work staffs.

Also, based upon the inputted reservation content, the actual time every work process is inputted. The activity data that has been stored are collected, so that the progress of the work process can be properly grasped. Then, the work conditions, the work contents, and the technical levels of the working staffs can be analyzed based on the collected activity data. Moreover, since the target value such as the work time is compared with the activity value, the motivation of the working staffs can be improved.

Also, the process control system of the present invention can manage the sales targets, and also can judge the management conditions based upon the activity value.

The present invention is not apparently limited only to the contents of the above-explained embodiments, but may be readily modified, changed, and substituted without departing to the technical scope of the accompanying claims by those skilled in the art.

What is claimed is:

1. A process control system comprising:
display means for displaying thereon an image;
repair-estimation time input means for inputting repair estimation time of a vehicle to be repaired;
repair-reserved data storage means for storing a repair-reserved data;
repair-reservable day/time data display means for displaying a repair-reservable day/time on said display means based upon the repair-reserved data of said repair-reserved data storage means; and
repair reservation determining means for determining a repair-reservation on the repair-reservable day/time displayed on said display means.

2. A process control system as claimed in claim 1 wherein:
said process control system further comprises:
repair-reservable day/time calculating means for calculating a repair-reservable day/time based upon both the repair estimation time inputted from said repair-estimation time input means and the repair-reserved data stored in said repair-reserved data storage means; and
said repair-reservable day/time data display means displays the repair-reservable day/time calculated by said repair-reservable day/time calculating means on said display means.

3. A process control system as claimed in claim 1 wherein:
said repair-estimation time input means corresponds to repair-estimation time calculating means for calculating repair-estimation time based upon various sorts of data as to a repairing portion of a vehicle.

4. A process control system as claimed in claim 1 wherein:
said repair-reserved data storage means stores thereinto repair-reserved data as to a plurality of repair work pits;
said repair-reservable day/time data display means displays repair-reservable day/time of each of said plural pits; and
said repair-reservation determining means selects any one of said repair-reservable day/time of the respective pits to thereby determine a repair reservation.

5. A process control system as claimed in claim 1 wherein:
said process control system further comprises:
repair-reservation completion day/time data display means for displaying repair-reservation completion day/time based upon the repair-reserved data stored in said repair-reserved data storage means; and
repair-reservation day/time changing means for changing the repair-reservation completion day/time into another repair-reservable day/time.

6. A process control system as claimed in claim 1 wherein:
said process control system further comprises:
working time input means for inputting actual repair work time which is actually consumed; and
work time comparing means for comparing estimated repair work time with the actual repair work time.

7. A process control system as claimed in claim 6 wherein:
said repair-estimation time input means inputs estimated repair work time with respect to each of plural work items;
said working time input means inputs actual repair work time with respect to each of the plural work items; and
said work time comparing means compares estimated repair work time with work time of each of the work items of the actual repair work time.

8. A process control system as claimed in claim 1 wherein:
said repair-reservable day/time data display means displays workable time per day on a time axis displayed on said display means; and
said repair-reservation determining means displays the estimated repair work time of the vehicle to be repair-reserved on a time axis in the same unit of said time axis displayed by said repair-reservable day/time data display means.

9. A computer readable storage medium for storing therein a program, wherein:
said program is used to cause computer to display repair-reservable day/time on display means based upon repair-reserved data, and also to determine a repair reservation on the repair-reservable day/time displayed on said display means; and
said computer comprises:
the display means for displaying thereon an image;
input means for inputting data; and
storage means for storing the repair-reserved data.
